(19) United States
(12) Patent Application Publication
(10) Pub. No.: US 2012/0235323 A1
(43) Pub. Date: Sep. 20, 2012

(54) PROCESS FOR MOLDING FROM A CAST

(75) Inventors: Domingo Anta Villar, (US); Jorge Gomez Pascual, (US)

(73) Assignee: ALUDEC, S.A. (FORMELY ALUDEC IBERICA, S.L.), Pontevedra (ES)

(21) Appl. No.: 13/349,024

(22) Filed: Jan. 12, 2012

(30) Foreign Application Priority Data
Mar. 18, 2011 (ES) P201130393

(51) Int. Cl. B29C 45/14

(52) U.S. Cl. 264/273

(57) ABSTRACT

Process for molding from a cast which includes the steps of: a) providing an insert which includes at least one through-hole; b) positioning this insert in a mold which has at least one feed channel, which leads to the end of this hole, such as to create a closed space, except for this hole; c) introducing through this feed channel, a hardenable fluid mass to form an overflow in this feed channel; d) leaving this hardenable fluid mass to harden, with this overflow, to form a hardened mass, without handling this hardened overflow, such as to reduce its area to less than that of the area of this hole; and e) withdrawing from this mold the ensemble of the insert and hardened mass, without handling this hardened overflow, such as to reduce its area to less than that of the area of this hole.

### REFERENCE TO RELATED APPLICATION

This application claims priority to Spanish Patent Application No. P201130393, filed Mar. 18, 2011, the disclosure of which is incorporated herein by reference.

### FIELD OF THE INVENTION

This invention refers to a process for molding from a cast.

More specifically, this invention refers to a process for molding from a cast around permanent inserts, to produce elements which in position of use include at least two visible zones of different surface characteristics (color, tone, shine, surface, etc.) which jointly form a substantially continuous face, that is to say, that these visible zones are juxtaposed.

### BACKGROUND OF THE INVENTION

It is known how to produce elements which in position of use include at least two visible zones of distinct superficial characteristics which jointly form a substantially continuous face.

A very frequent specific activity of this type is the production of emblems which in position of use include a substantially continuous face composed of two visible zones of different colors, for example, a first visible area of one color, which represents a shape which gives a distinctive character to the emblem, and a second visible area of a different color, which surrounds this first visible area to highlight it. In this example, the first visible area can have a shape such that it generates a multitude of closed areas, such that this second visible area does not appear as continuous, but rather will be divided into as many areas as closed areas make up this first visible area.

When industrializing these emblems, a widely used option is the application of graphic arts to print ink or paint of a color by silkscreen printing or pad printing on a substrate of another color, so as to create such first (or second) visible area with that ink or paint and create that second (or first) visible area with the visible part of the substrate, which remains free of ink or paint.

However, when dealing with emblems intended to be primarily exposed to the elements or to a large degree to varying weather conditions, such as, for example, the emblems on motor vehicles, the application of graphic arts can produce emblems which do not guarantee the necessary requirements of durability. It is well known that ink and paint have adherence problems which cause blistering or detachment over the useful life of the emblem and/or problems of resistance to light which cause discoloration or degradation and/or problems of resistance to chipping. If, furthermore, the substrate is substantially composed of metal, for example, aluminum, the aforementioned problems are combined with problems of metal corrosion (basically filiform corrosion).

In any case, this graphic arts solution is widely used, as has been stated, given the difficulties of producing emblems of this type by other means. For example, by means of molding from a cast, a first part can be molded, which presents an area in relief that forms a first visible area and afterwards one can mold (separately, for its subsequent application to this first part or directly on this first part) a second part, which has spaces corresponding to this part in relief. In this case, however, there arise problems, not only of durability, caused by limitations in the adhesion of both pieces to each other, but also of production, caused by the need to apply this second part onto possible cavities created by this first part, above all, when this first visible area creates small closed areas which must be filled to complete this second visible area, in which case this second part will actually be formed by various separate parts which must adhere individually to this first part.

### SUMMARY OF THE INVENTION

The purpose of the invention is therefore to provide a process for molding from a cast around permanent inserts, to produce elements which in position of use include at least two visible zones of distinct superficial characteristics which jointly form a substantially continuous face, which is simple and economic to set up, also if at least one of these zones is formed in actuality by separate parts, the process is therefore likely to produce elements of high durability.

In the context of this descriptive memorandum, the term “permanent insert” identifies a part, which is used in a process for molding from a cast, which is inserted into a mold to create the desired shape jointly with this mold, but which is independent of this mold, and which, after the molding procedure, is not withdrawn from the finished part, thus forming an integral part of this finished part.

More particularly, the purpose of the invention is a process for molding from a cast around permanent inserts, to produce elements which in position of use include a first visible area and at least a second visible area, these visible zones jointly forming a substantially continuous face, which comprises the steps of:

a) providing an insert, which includes:

a1) a first surface region, defined in relief, which corresponds with this first visible area, a second surface region, contiguous to this first surface region and which essentially overlaps this second visible area, and a third surface region,

a2) at least one through-hole, which goes from this second surface region to this third surface region;

b) positioning this insert in a mold which has at least one feed channel leading to the outside of this hole in this third surface region, such that this mold is closed around this third surface region and enters this second surface region and this mold creates a closed space, except for this hole;

c) introducing though a feed channel at least one hardenable fluid mass through this feed channel such that this hardenable fluid mass fills this space and overflows in this feed channel to form an overflow whose area is greater than the area of this hole;

d) leaving this hardenable fluid mass to harden, with this overflow until it is a hard mass, such that this hardened overflow mechanically anchors this hardened mass to this insert, without handling this hardened overflow in such a way that its area shrinks to less than the area of this hole; and

e) withdrawing from this mold all of the insert and hardened mass, which constitute this element, without handling this hardened overflow in such a way that its area shrinks to less than the area of this hole.

Preferably, the introduction of this hardenable fluid mass should be carried out by injection. Also, preferably, this feed channel runs, at least in part, contiguous with this insert, or is formed at least partially by this insert.

If the insert includes more than one through-hole between this second surface region and this third surface region, a different hardenable fluid mass can be introduced for each one of them, such that the same number of second visible zones will be produced as different hardenable fluid masses. In this case, it is preferable to leave one introduced hardenable fluid mass to harden at least partially before introducing another hardenable fluid mass.

Likewise, if the insert includes more than one through-hole between this second surface region and this third surface region, the introduction of the hardenable fluid mass can be carried out in such a way that this overflow is continuous between at least two holes.

As has already been pointed out above, this first visible area can create closed areas intended to form part of this second visible area, in which case, at least one through-hole will be provided between this second surface region and this third surface region corresponding to each closed area created.

### BRIEF DESCRIPTION OF THE DRAWINGS

These and other characteristics and advantages of the invention can be seen from the following description of a model of the invention, provided solely by way of example, and not limitatively, with reference to the drawings which are attached, in which:

FIG. 1 shows a first perspective view of an element fabricated using the process in accordance with this invention;

FIG. 2 shows a second perspective view of the element in FIG. 1;

FIG. 3 shows a perspective view of an insert which has an appropriate configuration for use in the process in accordance with this invention to produce the element in FIGS. 1 and 2;

FIG. 4 shows a second perspective view of the insert in FIG. 3;

FIG. 5 shows a perspective view of the element in FIGS. 1 and 2 positioned within a mold which has an appropriate configuration for use in the process in accordance with this invention to produce the element in FIGS. 1 and 2; and

FIG. 6 shows a transverse cut view of the element in FIG. 1, along the line A-B of FIG. 1.

### DETAILED DESCRIPTION OF THE INVENTION

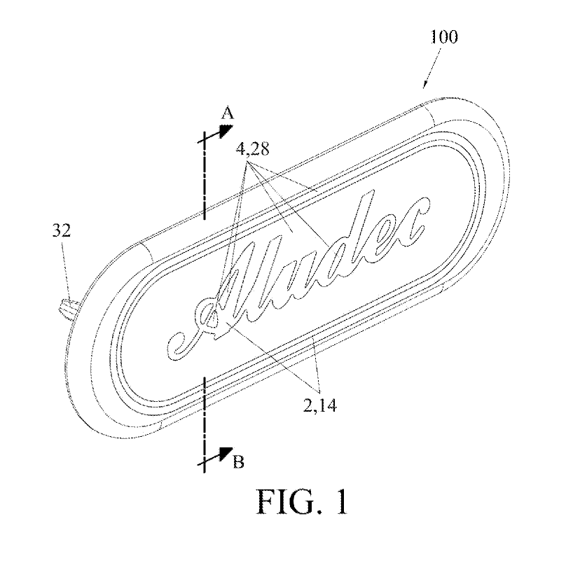

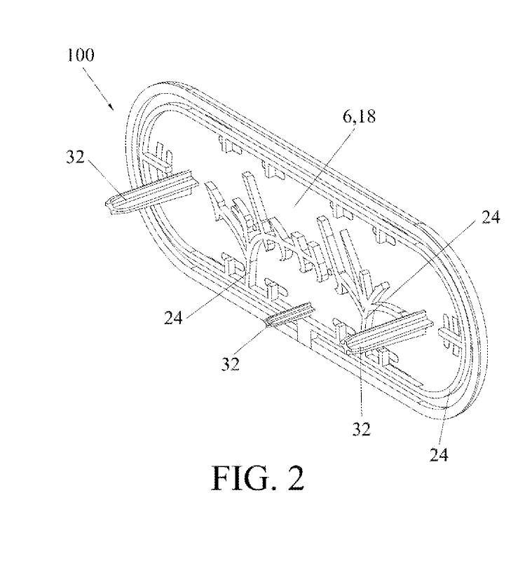

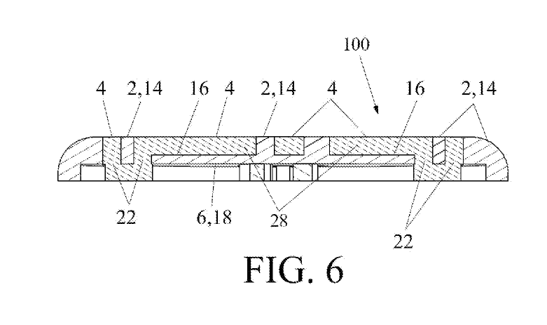

Referring initially to FIGS. 1, 2 and 6, an example of element 100 is shown manufactured using the process in accordance with this invention. This element 100 includes two zones of different surface characteristics which will be visible in position of use. Specifically, a first visible area 2 with a smooth surface and a second visible area 4 with a rough service. This element 100 similarly includes a third area 6, which in this example has extensions 32 for joining to some means of support and will remain hidden in position of use. Although it is preferable that this third area remains hidden in position of use, the process for the invention is not limited to that.

Also some overflows 24 of hardenable mass 28 and some holes 22 crossing through this hardenable mass 28 are shown.

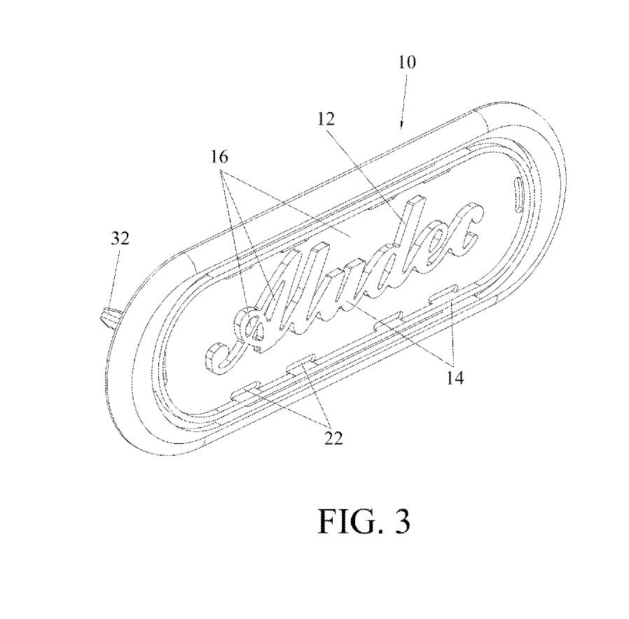

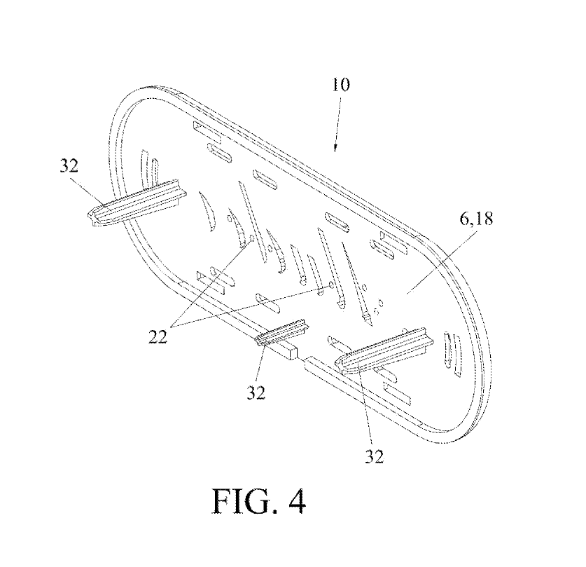

Referring now to FIGS. 3 and 4, an insert 10 is shown, which has an appropriate configuration for use in the process in accordance with this invention to produce this element 100.

This insert 10 comprises a relief 12 which has a flat crown, which constitutes a first surface region 14 of this insert 10, which in turn will constitute this first visible area 2 of this element 100 once it is produced. This insert 10 also comprises a second surface region 16 intended to receive a hardenable fluid mass 20, whose front, after transformation of this hardenable fluid mass 20 into this hardened mass 28, will constitute this second visible area 4 of this element 100. Lastly, this insert 10 comprises several through-holes 22, which cross from this second surface region 16 to a third surface region 18, which will constitute the third hidden area 6 of this element 100.

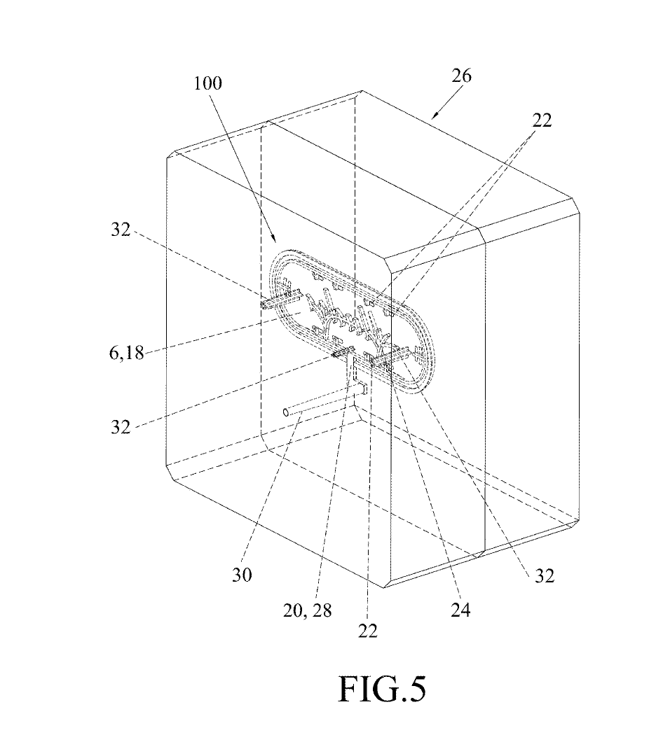

Lastly, FIG. 5, in combination with FIGS. 1, 2 and 6, shows a perspective view of element 100 positioned within a mold 26, which has an appropriate configurations for use in the process in accordance with this invention to produce this element 100. This mold 26 closes around this first surface region 14, that is to say, an appropriate insert 10 is applied, such as to create, within this second surface region 16, and this mold 26, a hermetically sealed space except for these through-holes 22, extended by some respective feed channel s 30, intended to be filled with this hardenable fluid mass 20 to create this second visible area 4 after transformation of this hardenable fluid mass 20 into a hardened mass 28. This mold 26 comprises an internal face with at least one rough part 26 corresponding to this space, for the purpose of obtaining a rough service in this second visible area 4, as mentioned above.

In this example, this first surface region 14 of this insert 10, which in turn constitutes this first visible area 2 of this element 100, coincides with the flat crown of this relief 12. However, this first surface region 14, and thus this first visible area 2 could comprise the flat crown of this relief 12, and furthermore part of the wall of this relief 12. In this case, this first visible area 2 of this element 100 and this second visible area 4 of this element 100 will jointly form a substantially continuous face, but with a difference in height.

A sample process in accordance with this invention to produce element 100 by means of the use of this insert 10, this mold 26 and this hardenable fluid mass 20 will be explained below, referring to the figures.

Once there is this insert 10, it is positioned in this mold 26 in such a way that this mold 26 closes around this first surface region 14.

Next, through the accessible end of these through-holes 26, that is to say, the end that opens into this third surface region 18, a volume of this hardenable fluid mass 20 is injected greater than the volume of the space created between the second surface region 16 and this mold 26, such that some overflows 24 are formed in the feed channels 30 of the mold 26, whose area is greater than the area of these through-holes 22.

This hardenable fluid mass 20 is then left to harden, with these overflows 24 into a hardened mass 28, such that these hardened overflows 24 mechanically anchor this hardened mass 28 to this insert 10, giving rise to element 100 formed by the solidified ensemble of insert 10 and hardened mass 28.

Lastly, this element 100 is withdrawn from this mold 26. Of course, while maintaining the principle of the invention, the constructions and the details of construction can vary widely compared to those described and illustrated in this document by way of example and not limitatively, without going beyond the scope of protection of the invention as defined in the attached claims.

For example, by way of illustration and not limitatively, the following options may be considered.

An element having these first and second visible zones and also had at least one additional visible area in position of use would be within the scope of the invention.

Likewise, in this document this first visible area is smooth and this second visible area is flat, but alternatively or additionally to a structural surface difference, the surface difference could be visual, for example, the color, the shine, the tone, the fluorescence . . . or a combination of them, without going beyond the scope of the invention. In this case, the insert and the hardenable fluid mass can intrinsically incorporate the characteristic in question. For example, the hardenable fluid mass can be a thermoplastic in a fluid state, colored with a different color from that of the insert. For certain applications, it is recommended that the hardenable fluid mass have a high resistance to solar radiation, such as for example an ASA or a PMMA, and at times, PMMA is preferable in order to provide, on being injected against a polished cavity, such as the internal face of the mold, a finish with much greater shine and visual depth.

On the other hand, the example described in detail in this document includes the introduction of this hardenable fluid mass 20 by means of molding from a cast by injection, but any other applicable alternative would be within the scope of the invention, for example, molding from a cast by gravity, centrifuge casting, etc.

Also within the scope of the invention is the possibility of manufacturing this insert 10 by means of any other process. For example, this insert 10 can be a part manufactured by the injection of a chromable thermoplastic (ABS, ABS-PC or polyamide) and optionally metalized by means of a galvanic process, or it may be a part manufactured by injection of a thermoplastic different than those mentioned above and optionally metalized by means of cathodic pulverization (also known by its English term “sputtering”) or by means of coating by means of physical deposition of vapor (also known as covering by PVD from the initials of the English term “Physical Vapor Deposition”).

Similarly, this insert 10 can be formed by several juxtaposed parts (and optionally supported). In this case, if these several juxtaposed parts are not supported by each other, the technical expert can set and will appropriately set the parameters of the process in accordance with the invention, in order that the mechanical anchoring arising from it likewise attains the desired structural stability of the permanent insert.

Lastly, it can be provided for the aforementioned overflows to have a final form that will bond or serve in the bonding of the element to these means of support.

The present invention has been described as set forth above. It is to be understood, however, that other expedients known to those skilled in the art or disclosed herein may be employed without departing from the spirit of the invention.

What is claimed is:

1. A process for molding from a cast around a permanent insert, to produce an element which in position of use includes a first visible area and at least a second visible area, the visible areas jointly forming a substantially continuous face, the process comprising the steps of:
a) providing an insert, which includes:
a1) a first surface region, defined in a relief, which corresponds with the first visible area, a second surface region, contiguous to the first surface region and which essentially overlaps the second visible area, and a third surface region,
a2) at least one through-hole, which goes from the second surface region to the third surface region;
b) positioning the insert in a mold which has at least one feed channel which leads to the outside of the hole in the third surface region, such that the mold is closed around the first surface region and enters the second surface region and the mold creates a closed space, except for the hole;
c) introducing through the feed channel at least one hardenable fluid mass such that the hardenable fluid mass fills the space and overflows in the feed channel to form an overflow whose area is greater than the area of the hole;
d) leaving the hardenable fluid mass to harden, with the overflow until it is a hard mass, such that the hardened overflow mechanically anchors the hardened mass to the insert, without handling the hardened overflow in such a way that its area shrinks to less than the area of the hole; and
e) withdrawing from the mold all of the insert and hardened mass, which constitute the element, without handling the hardened overflow in such a way that its area shrinks to less than the area of the hole.

2. The process for molding from a cast in accordance with claim 1, wherein in step c) the hardenable fluid mass is introduced by injection through the feed channel.

3. The process for molding from a cast in accordance with claim 1, wherein in step b) the insert is positioned in a mold in which the feed channel runs, at least partially, contiguous to the insert and/or in which the feed channel is formed, at least partially, by the insert.

4. The process for molding from a cast in accordance with claim 1, wherein, by including the insert several through-holes between the second surface region and the third surface region, in step c) at least two hardenable fluid masses different from each other are introduced, each different hardenable fluid mass being introduced by a different hole.

5. The process for molding from a cast in accordance with claim 4, wherein the hardenable fluid masses that are different from each other being introduced sequentially.

6. The process for molding from a cast in accordance with claim 4, wherein the hardenable fluid masses different from each other being introduced sequentially and each one of the different hardenable fluid masses being left to harden before injecting the next of the different hardenable fluid masses.

7. The process for molding from a cast in accordance with claim 1, wherein, by including the insert and several through-holes between the second surface region and the third surface region in step c) the hardenable fluid mass is introduced by the feed channel, such that the hardenable fluid mass fills the space and overflows so as to form in the feed channel an overflow whose area is greater than the area of the hole, extending the overflow in a continuous way between at least two holes.

8. The process for molding from a cast in accordance with claim 1, wherein, by including the first visible area closed areas, which form part of the second visible area, in step a) an insert is provided which includes at least one through-hole between the second surface region and the third surface region corresponding to each one of the closed areas.

9. The process for molding from a cast in accordance with claim 1, wherein by providing in step a) an insert which is formed by several juxtaposed parts.

10. The process for molding from a cast in accordance with claim 1, wherein by providing in step a) an insert which is formed by several juxtaposed parts supported by each other.

11. The process for molding from a cast in accordance with claim 1, wherein in step a1) the first surface region, is defined by the relief, which corresponds to the first visible area, such that the first visible area of the element coincides with the flat crown of the relief, such that the first visible area of the element and the second visible area of the element jointly form a substantially continuous face, but with a difference in height.

12. The process for molding from a cast in accordance with claim 1, wherein in step a1) the surface region is defined by the relief which corresponds with the first visible area such that the first visible area of the element coincides with the flat crown of the relief and part of the wall of the relief, such that the first visible area of the element and the second visible area of the element jointly form a substantially continuous face, with a difference in height.
